(19) United States
(12) Patent Application Publication
(10) Pub. No.: US 2023/0120016 A1
(43) Pub. Date: Apr. 20, 2023

(54) One-Piece Concave-Lid

(71) Applicant: Sastry Kodavati Ganti, Chicago, IL (US)

(72) Inventor: Sastry Kodavati Ganti, Chicago, IL (US)

(21) Appl. No.: 17/503,273

(22) Filed: Oct. 16, 2021

(51) Int. Cl. A47J 36/06

(52) U.S. Cl. CPC A47J 36/06

(57) ABSTRACT

A spherical or conical profiled One-Piece Concave Lid devoid of attachments, having needed vent passages between its upper and under sides:
adequately seals and covers stably a pot's opening, even when the Lid is inadvertently or deliberately placed off-centered,
directs any condensates formed on the lid's underside or escaped to the lid's upper side, to gravitate radially to the lid's center, and drains them back into the pot,
allows compact nesting of similar lids regardless of their sizes, thus reducing storage space requirements,
accommodates a single lid to fit over several pot openings regardless of the pots' opening rims' design style,
simplifies and betters the lid's cleaning due to the absence of nooks and crannies at junctions with handles,
facilitates cleaning in less time, and with less cleaning agents, and
maintains lower material, manufacturing, packing and shipping costs.

### CROSS REFERENCE TO RELATED APPLICATION

This application claims the benefit of provisional patent application, EFS ID 41502555, Appl. No. 63/135,714, filed—2021 Jan. 10, confirmation number 9189, by the present inventor under title—“Concave Lid for Utility Pot”.

This application also cross references with:

63/140,811 (Jan. 23, 2021) (“Universal Tongs for Indented Pot”), &

63/134,908 (Jan. 7, 2021) (“One Piece, No attachments, Utility Pot”).

The three applications are connected in several areas.

### FEDERAL SPONSORSHIP

None

### SEQUENCE & LISTING PROGRAM

None

### PRIOR ART REFERENCES

U.S. Pat. No. 9,505,528 B2 by Thomas B. Walker, U.S. Pat. No. 9,751,566B2 by Samuel Lincoln Brannock, US20040250690A1 by Thomas Restis, U.S. Pat. No. 7,617,948B2 by Stanley Kin Sui Cheng, HU215273B by Hans Fingerle Todd W. Kroscher U.S. Pat. No. 5,887,751A

### BACKGROUND OF THE INVENTION, FIELD OF INVENTION

This invention relates to the shape, design & use of a concave shaped lid (opposed to the normal convex shaped lid), used to cover the cylindrical openings of pots & containers, generally used in kitchens & elsewhere.

The concave lid ‘has no & needs no attachments’ for handling it, since it is provided with formed features to handle it with a stand-alone vise grip pliers style utensil.

The manner of using the lid is simply to place the lid on the circular opening of a pot or a container with the concavity down, with such opening being smaller than the diameter of the concave lid.

### BACKGROUND OF THE INVENTION, PRIOR ART & ITS DISADVANTAGES

The lid for pots has been predominantly convex in shape, requiring precise centered-only placement on a pot with the lid's top-heavy convexity being above the pot's opening.

A convex lid needs an attachment for handling it; that increases the lid's space requirements & its design complexity.

Convex lids are, and need to be, individualized for the size & shape of a pot's opening.

The result is the requirement of as many lids as there are pots, & the lids cannot be interchanged for pots with different openings & openings' styles. The convex lid, devoid of stability, cannot be placed off centered on a pot, as when needed for throttling the vapors coming out of the pot.

A convex lid being top heavy, is not stable & steady when errored in its placement & hence requires matching mating nesting designs for both the pot's & the lid's rims.

All the design complexities add manufacturing & material costs, extra space requirements everywhere, —in using, storing, packaging, shipping, etc.

Nesting & stacking of convex lids is not possible due to their protruding attachments.

Since each pot opening (design) needs its own matching lid (design) with attachments, Often searching for the correct lid each time becomes an annoying, tedious task.

Any evaporating/rising fluids from inside the pot forming a condensate on lid's underside, will gravitate unwantedly along the inside of the lid's dome toward its outer rim & frequently ooze out as overflows along the outside of the lid-pot's rim junction.

If the lid has been provided with vent holes, similar undesirous overflow direction results but on outside of the lid.

Efficient cleaning of a convex lid, due to the nooks & crannies presented by its attachments & rim design, not only becomes a chore, but also requires excessive amounts of, —pre-prep & cleaning time, —cleaning agents & cleaning tools.

Eventually, these hard-to-reach regions will retain a gradual buildup of undesirable particulates, which, by any means become impossible to get rid of.

Excessive aggressive attempts at cleaning such regions prematurely damage the surface finish of the lid.

### BACKGROUND OF THE INVENTION, OBJECTS & ADVANTAGES

The lid described here is concave in shape, —spherical or conical. It ‘has no & needs no’ attachments. It may have one or more vent holes placed as deemed ideal.

The concave lid removes the necessity of either the pot or the lid needing mutually nesting, matching rim designs for pots or any precise placement of the lid on a pot.

A single, diametrically adequately oversized, lid will fit over the openings of a multitude of pots within a range of diameters of pot openings.

The lid even if placed off center over a pot's opening, still will effectively cover the pot's contents, regardless of the complexity of the pot's rim shape, —because of the contact by the concavity's underside.

Any rising content, such as steam/fluids etc., contacting the underside of the lid will gravitate in the desirous manner, radially to the pot's center as a condensate on the underside of the lid.

The lid will not need any handling attachment, since commonly found kitchen tongs or various other special but simple tools described here will easily handle it's placement or removal, when hot or cold.

A few gentle horizontal taps to a placed lid's rim will move it sufficiently off center allowing it to be grabbed at the lid's edge.

One or more strategically placed holes in the lid will provide effective venting & draining of formed condensate on the upper side radially to the center of the lid, and back into the pot. The holes can also be access passages for additives or content stirrers into the pot without removing the lid.

Cleaning & maintaining the cleanliness of the lid becomes easier & simpler, while reducing the requirements of both time & cleaning agents.

Just one or two lid sizes will cover a large range of pot openings, saving much space in the sink, counter, & cabinets.

The stability of a lid placed on a pot opening is improved due to its bottom heaviness, regardless of any placement errors.

The concavity of the lid need not be large, whereby any encroachment by it into the pot's interior can be negligible. As will be seen, a shallow rim wall for a shallow concave lid with vent holes will provide much space for overflow condensate with very little encroachment of lid into the pot.

A metal lid of shallow concavity and a few minor design changes can behave both like a lid as well as a frying pan.

### SUMMARY

The One-Piece No-attachments concave lid, improves &/or simplifies:
its own design,
a pot's design,
its efficacy as utilization with multiple pots,
its ability to throttle gases & fluids in the pot without overflows,
its ability to capture rising fluids as condensates & drain them back into the pot regardless they be underside or outer side the lid,
its maintenance,
its ability to compactly nest with other lids for storage or any other,
its manufacturing, packing, and shipping costs,
its overall cost versus value,
its ability to take inaccurate placement on the pot,
its suitability as one size fits many pots.

Note: Following Acronyms are Used Wherever Appropriate
OPNACL is for One-Piece No-Attachments Concave-Lid
VGPCFL is for ‘Vise Grip Pliers (style) Clamps—for—Flanged Lid’
OPNACLW is for One-Piece No-Attachments Concave Lid-with-a-Wall
OPNACLF is for One-Piece No-Attachments Concave Lid-with-a-Flange
OPNAXLF is for One-Piece No-Attachments Convex Lid-with-a-Flange

### DRAWINGS, —FIGURES

FIG. 1 OPNACLs, —basic embodiments vertically stacked, top view

FIG. 1A Enlarged detail elevation view of vertically stacked OPNACLs

FIG. 1B OPNACLs, —basic embodiments vertically stacked, elevation view

FIG. 2 One sufficiently large OPNACL shown covering many pots' openings

FIG. 2A Detail: OPNACL covering pots' openings of various shapes & sizes

FIG. 3 OPNACL in off centered position, so placed inadvertently or deliberately

FIG. 3A Detail elevation view of the off-centered OPNACL with throttling gap

FIG. 4 Top view: nest of differently sized OPNACLs into a compact stack

FIG. 4A Enlarged detail: differently sized OPNACLs in the compact stack

FIG. 4B Elevation view: nest of differently sized OPNACLs into a compact stack

FIG. 5 OPNACL, pushed/or pulled/or tapped off center, for gripping access

FIG. 6 Illustration: underside condensate at OPNACL draining back into pot

FIG. 6A Illustration: upper side condensate at OPNACL draining back into pot

FIG. 7 Special Tongs to handle OPNACL by gripping its rim, tangentially

FIG. 7A Special Tongs gripping an OPNACL by its rim, perspective view

FIG. 7B Special Tongs gripping an OPNACL by its rim, elevation view

FIG. 8 OPNACL's vent/throttling holes covered/uncovered, with a Mini OPNACL

FIG. 9 Special OPNACL-Edge-Gripper, for finger-squeeze-grip of OPNACL

FIG. 9A Enlarged detail of special OPNACL-Edge-Gripper

FIG. 9B OPNACL-Edge-Gripper positioned to finger-squeeze-grip OPNACL

FIG. 10 1^{st} alternate embodiment: Spherical OPNACL, with a flat bottom

FIG. 10A 2^{nd} alternate embodiment: Spherical OPNACL, reverse bump on the flat

FIG. 11 3^{rd} alternate embodiment: OPNACLWs, nearly-same-size, nested, top view

FIG. 11A Enlarged elevation view, compactly nested OPNACLWs, nearly-same-size

FIG. 11B Compactly nested OPNACLWs, nearly-same-sizes, elevation view

FIG. 12 Flat bottomed (1^{st} or 2^{nd} embodiment) OPNACL's use on pots' openings

FIG. 12A Enlarged view, flat bottomed OPNACL's use on varying pots' openings

FIG. 13 Spherical OPNACLW, with a + shaped slot, to insert a Content Stirrer

FIG. 13A OPNACLW & a Mini-OPNACL, a cover with matching + shaped slots

FIG. 14 4^{th} alternate embodiment: spherical OPNACLW with + slot

FIG. 14A Spherical Mini-OPNACL with a + matching slot, for throttling

FIG. 14b A matching + shaped Content Stirrer

FIG. 15 5^{th} alternate embodiment: OPNACL with radial tangs & Tang-Handler

FIG. 15A Detailed view: OPNACL Tang-Handler inserted into a tang of OPNACL

FIG. 15B Elevation view: OPNACL with radial tangs & Tang-Handler

FIG. 15C Tang-Handler for OPNACL with radial tangs

FIG. 16 6^{th} alternate embodiment: OPNACL & Anti-Slide-Bumps on underside

FIG. 16A OPNACL with bumps, placed off-centered on pot to maintain lid's position

FIG. 16B Typical Anti-Slide-Bumps on underside of OPNACL

FIG. 17 7^{th} alternate embodiment: OPNACLF gripped by a VGPCFL, top view

FIG. 17A The OPNACLF & the gripping VGPCFL, elevation view

FIG. 17B Detail View: OPNACLF, its flange gripped with a VGPCFL

FIG. 18 Top view: 8^{th} embodiment OPNAXLF with matching VGPCFL

FIG. 18A Elevation view: 8^{th} embodiment of OPNAXLF & VGPCFL

FIG. 18B Detail View: OPNAXLF, matching VGPCFL & a matching pot's rim

### DRAWINGS, —REFERENCE NUMERALS

100 Top view: three representative OPNACLs stacked
102 Spherical OPNACL (with no vent hole)
104 Spherical OPNACL (with one vent hole)
106 Conical OPNACL (with one vent hole)
108 Vent hole, shown arbitrarily at OPNACL's center/bottom
114 Pots with different opening sizes & rim designs
116 Single OPNACL, adequate for several opening diameters & designs
120 OPNACL shown off centered, placed so inadvertently or deliberately
122 Off centered OPNACL, a means for throttling contents or gripping OPNACL
124 Schematic arrow: shows push/or pull/or edge tap to off center OPNACL
128 Stacked OPNACLs of different sizes, showing compact nesting
130 Common kitchen tongs, adequate to grip the OPNACL by its rim
134 Schematic Illustration: condensation flow on underside of OPNACL
136 Schematic Illustration: condensation flow on upper side of OPNACL
140 Typ. lower tang of special tongs, to rest the bottom surface of OPNACL
142 Upper arm of the special tongs for squeeze-holding the OPNACL's rim
144 Typ. upper tang of special tongs, to locate & backup the rim of OPNACL
150 Mini OPNACL, to cover fully vent hole—or—to throttle the venting
151 OPNACL with several vent/throttling holes
152 The Mini OPNACL illustrated ‘pushed’ out for full venting/throttling
154 Finger-over-travel-preventer, for safety when gripping a hot OPNACL
156 Gripping-tang of OPNACL-Edge-Gripper to grip OPNACL by its rim
160 1^{st} alternate embodiment: OPNACL with a flat bottom
162 2^{nd} alternate embodiment: OPNACL with a reverse-bumped flat bottom
164 3^{rd} alternate embodiment: OPNACLWs, a compactly nested stack, top view
166 Wall of a 3^{rd} embodiment spherical OPNACLW, increases capture volume
170 Hand knob, to rotate in-place Content Stirrer to stir a pot's contents
172 Specially designed ‘insertable’ + shaped Content Stirrer
174 Vanes of the + shaped Content Stirrer
176 4^{th} alternate embodiment: OPNACLW & + shaped slot for Content Stirrer
178 Mini-OPNACL with matching + slot, throttles the slot in OPNACLW
180 Pot, shown in section
190 5^{th} alternate embodiment: OPNACL with Radial Tangs
192 Radial-Tangs-OPNACL's Tang-Handler, insertable into a Radial Tang
194 6^{th} alternate embodiment: OPNACL, Anti-Slide-Bumps on underside
196 Anti-Slide-Bumps prevent OPNACL's sliding when it is off centered
198 As desired venting/throttling position, maintained by the Anti-Slide-Bumps
200 Anti-Slide-Bumps preventing OPNACL from sliding & centering self
220 7^{th} alternate embodiment: OPNACLF, with flared flange rim wall
222 a special VGPCFL for OPNACLF, shown gripped with wingnut tightened
224 Flared flange on the cylindrical vertical wall of OPNACLF
226 Tightened wing-nut secures gripped status of VGPCFL with OPNACLF
228 a pot & its matching flange to that of OPNACLF, for same VGPCFL
229 Resting surface for VGPCFL, instantly aligns its gripper jaws to OPNACLF
230 Rim wall of OPNACLF, the vertical portion below the flange

### DETAILED DESCRIPTION

The invention relates to a concave shaped lid, devoid of handles (OPNACL) & other attachments, that which can be used to cover a circular opening of a pot. The ideas presented here are contrarian to the construction and use of the traditional convex lid.

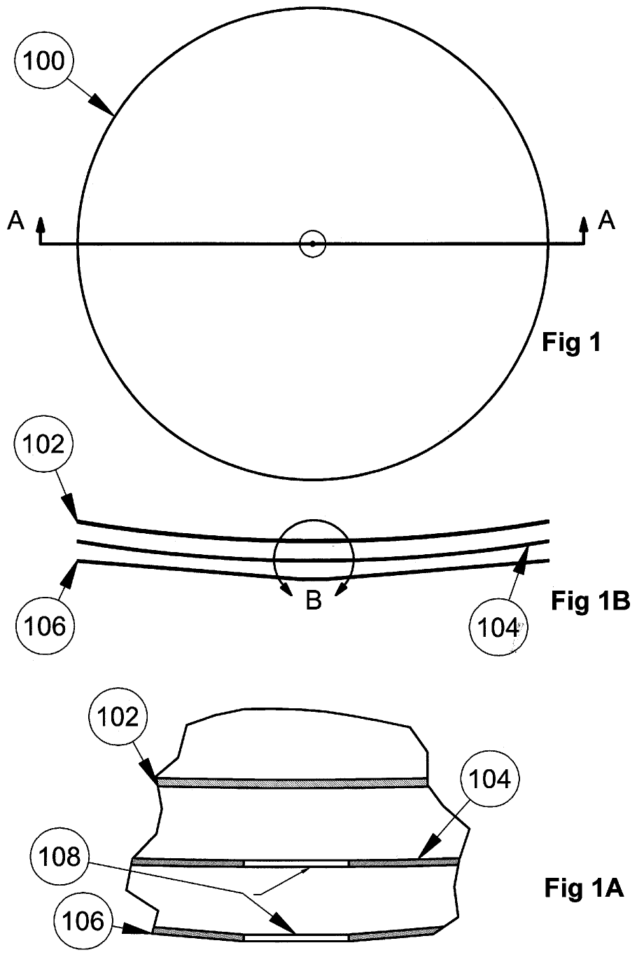

Referring to FIGS. 1, 1A, & 1B:

OPNACL has no, and needs no attachments (#100, #102, #104, #106).

Generally, preferred OPNACL is spherical, (#102, #104) but it can be conical (#106).

The OPNACL may have strategically placed venting/throttling hole(s) (#108).

The vent hole(s) can be access points to add fluids, powders, spices, etc. from outside the pot without removing the OPNACL

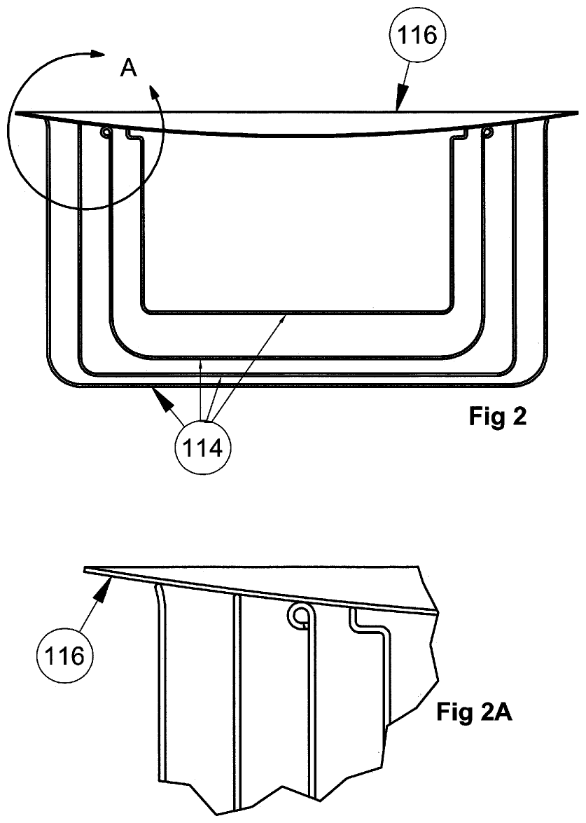

Referring to FIGS. 2 & 2A:

In OPNACL's use, it (#116) is simply placed on the opening of the pot with the concavity downward into the pot (#114). Precise placement is not needed.

Since the concaveness is designed to be shallow, the OPNACL does not encroach into any significant space required by the pot for its contents.

In its placement, the OPNACL does not have to be centered accurately because its diameter is larger than the largest pot's opening usable for a specific OPNACL.

A certain amount of off-centeredness can be tolerated.

OPNACL of sufficient diameter size may be used to cover various pot openings & pots' rim configurations (#114). This reduces the number of OPNACL sizes required.

The OPNACL, being bottom heavy, is inherently self-centering & self-stabilizing when placed on an opening. It has no tendency to topple over.

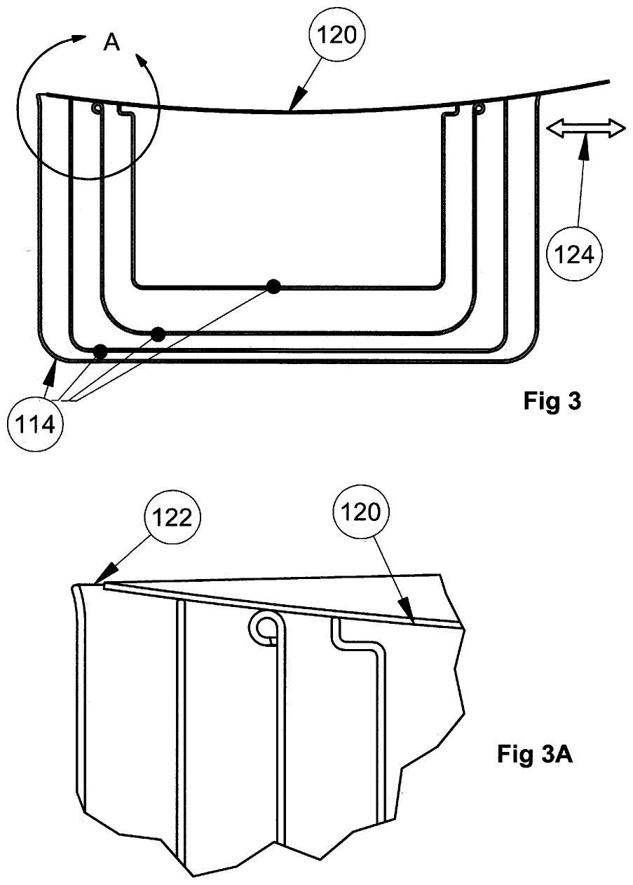

Referring to FIGS. 3 & 3A:

A pot's contents can be vented/throttled by controlling the OPNACL's placement (#120, #122).

#124 is a schematic illustration how an OPNACL can be pushed, pulled or tapped into any stable desired position.

Off centering OPNACL permits edge gripping OPNACL with ease.

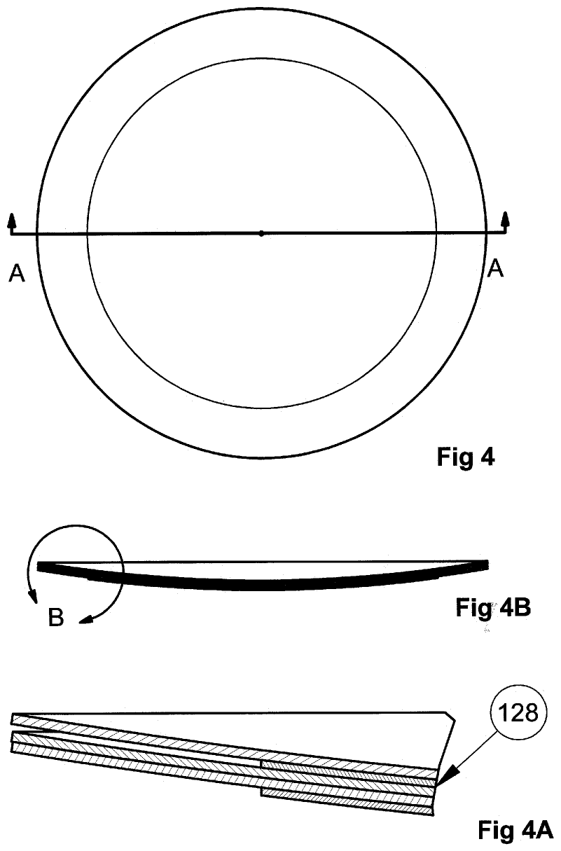

Referring to FIGS. 4, 4A & 4B:

OPNACLs of similar concavity can be compactly nested, say, for storage (#128).

Only two sizes of OPNACLs are shown but there is no limitation.

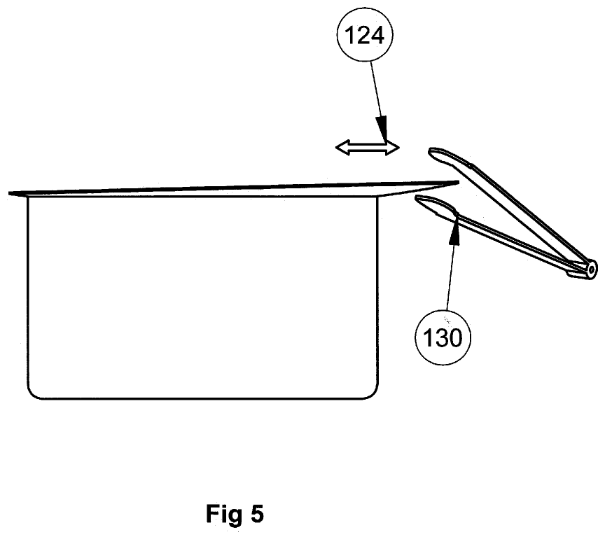

Referring to FIG. 5:

A common kitchen tongs (#130) can be used to handle an OPNACL. If the overhang of the OPNACL over the pot rim is not sufficient to grab it, then it can be pushed or pulled or tapped off center (#124) & then gripped.

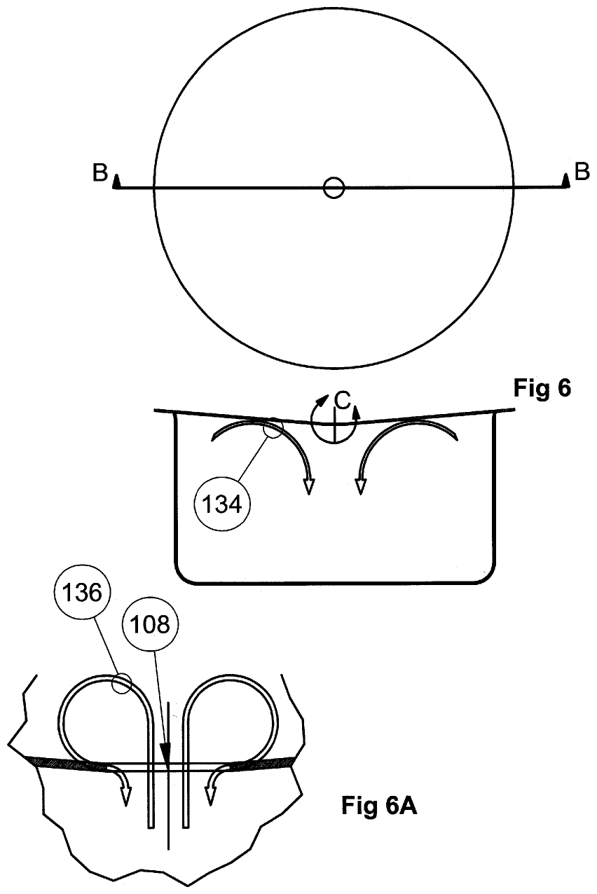

Referring to FIGS. 6 & 6A:

Illustrative flow arrows (#134, #136) show how rising fluids becoming condensates drain back into the pot, be they from the underside or upper side of OPNACL.

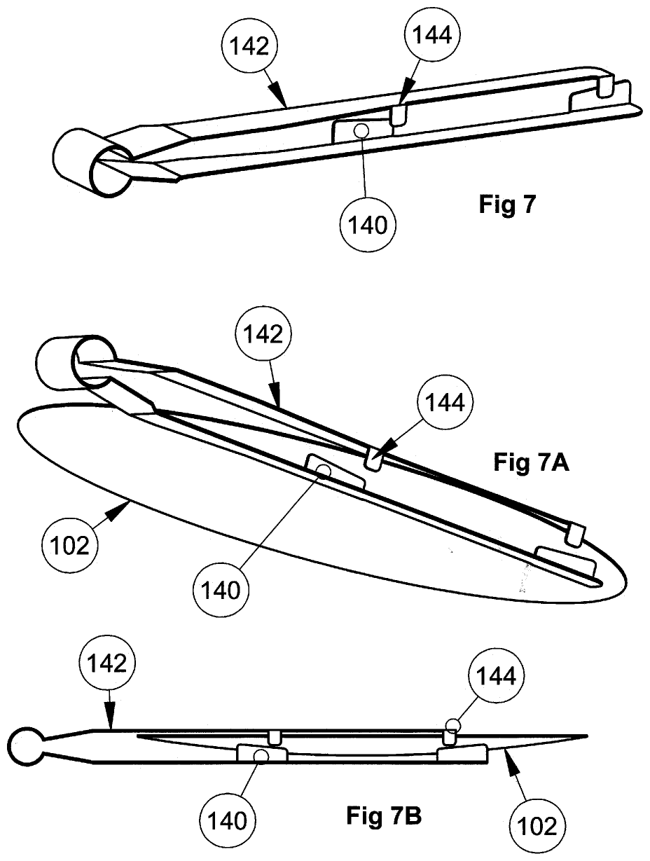

Referring to FIGS. 7, 7A & 7B:

A special design tongs shown can grip OPNACL tangentially. This requires no disturbing of the OPNACL's position on the pot.

Tangs #144 will wall off the rim of the OPNACL radially. Tangs #140 will act as the underside rest for the OPNACL. Squeezing the upper arm #142 downward will grip the OPNACL over tongs #140.

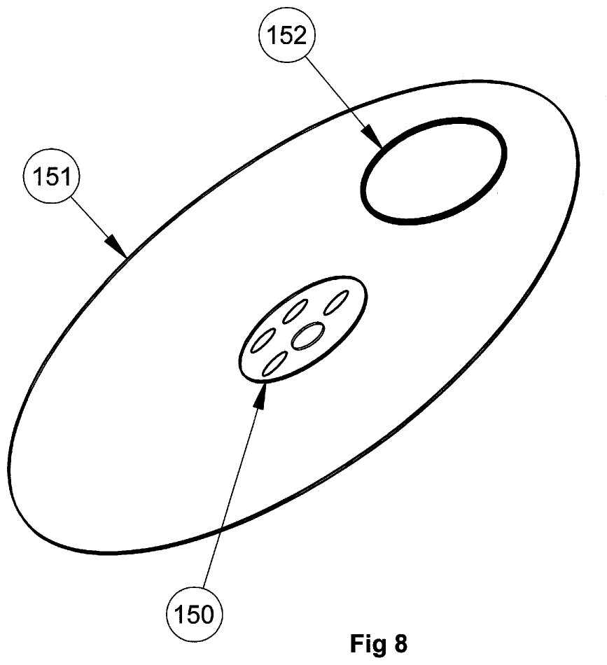

Referring to FIG. 8:

Mini-OPNACL (#150) used to cover vent holes. Mini-OPNACL can be pushed aside as needed (#152) by using any kitchen tool such as a butter knife, for throttling or full venting.

The shallowness of concavity & friction between the two OPNACLs will prevent. Mini-OPNACL from sliding back from a preferred placement.

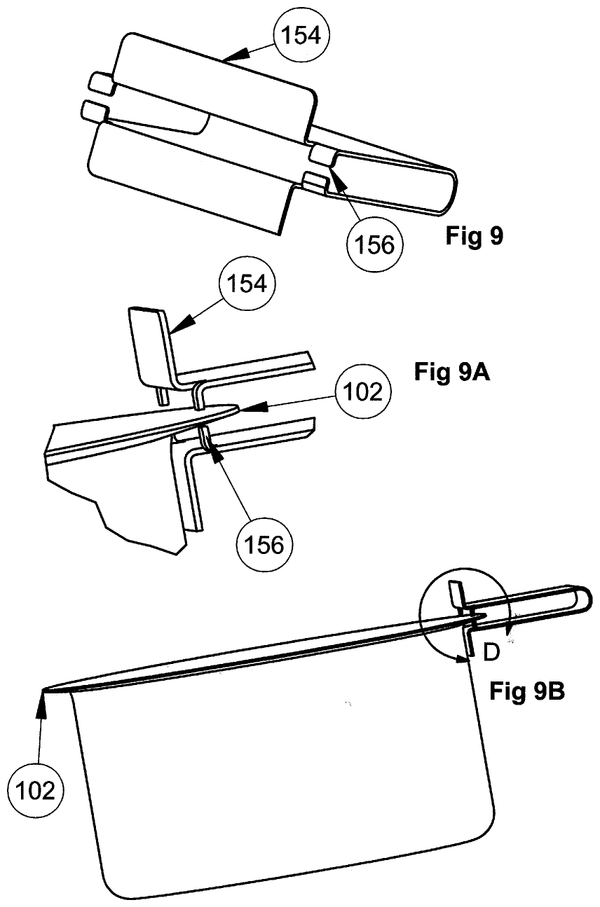

Referring to FIGS. 9, 9A & 9B:

Alternate design of tongs to handle an OPNACL by its rim. Tangs #156 are squeezed to grab the OPNACL using, say, thumb & index finger. The large tangs #154 will prevent finger over travel & inadvertently touching a hot OPNACL or pot.

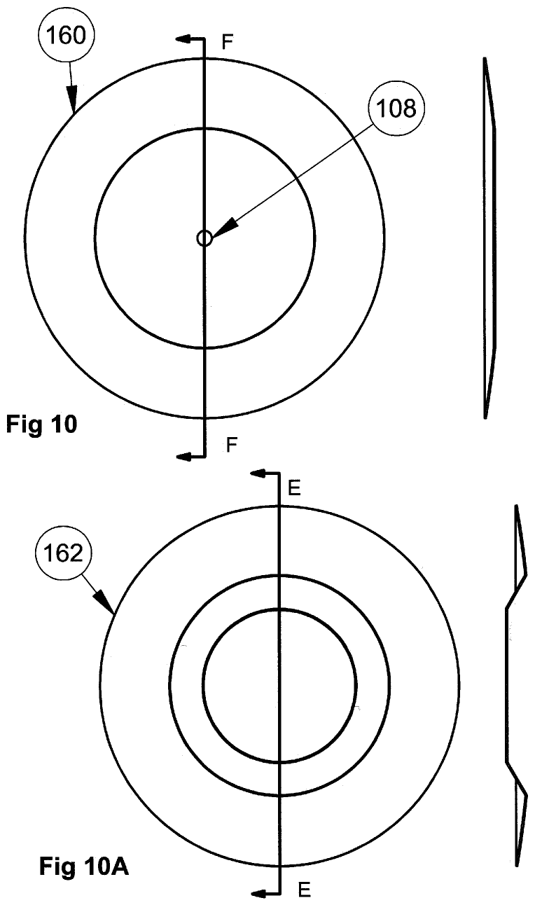

Referring to FIGS. 10 & 10A:

1^{st} & 2^{nd} alternate embodiments of OPNACL. Bottom of OPNACL is modified to decrease lid encroachment into pot.

The sphericalness of OPNACL is flattened as shown in 1^{st} embodiment of FIG. 10, to minimize the OPNACL's encroachment into the pot.

Encroached space into the pot by the OPNACL can be regained by creating an upward bump in the OPNACL as shown in 2^{nd} embodiment of FIG. 10A.

(Enough spherical underside area can be retained to accommodate several pot openings.)

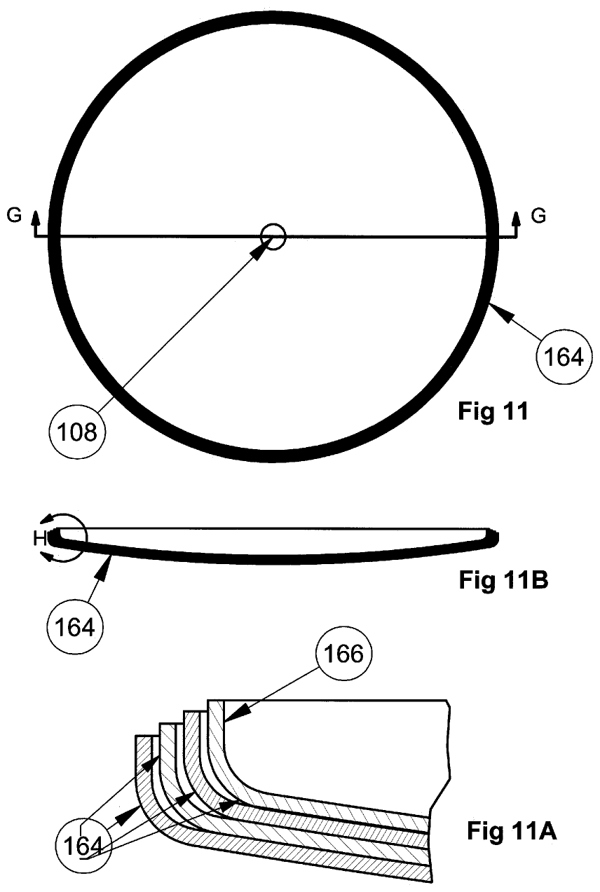

Referring to FIGS. 11, 11A, & 11B:

3^{rd} embodiment: OPNACLs (#164) are provided with rim walls (#166). The wall provides for extra condensate accumulation on the upper side surface. It also provides a means to grip the OPNACL by the wall and portion of the concave underside, using special tongs. The special tongs will be substantially similar to #222 with the addition of the outer jaw of #222 encroaching to the underside of #220 the lid.

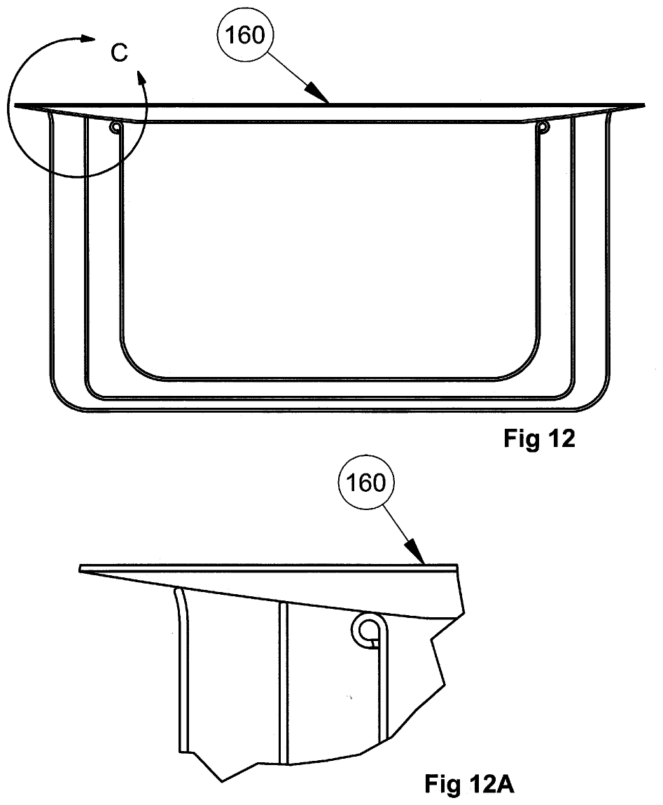

Referring to FIGS. 12 & 12A:

A flat bottomed (1^{st} or 2^{nd} embodiment) OPNACL's spherical portion (#160) is used for several pot openings, albeit for limited number of sizes. Pots of lesser diameter may opt to use the flat portion of the OPNACL.

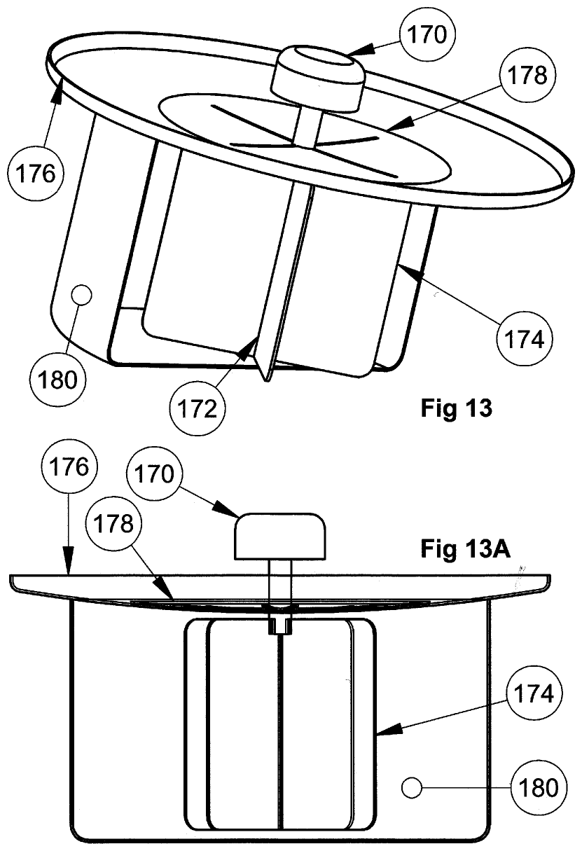

Referring to FIGS. 13 & 13A:

4^{th} embodiment: OPNACL (#176) with a + shaped slot through which a Content Stirrer (#172) with matching vanes (#174) can be inserted. To minimize the escape of contents from the pot #180 through gaps at + shaped slot, smaller OPNACL (#178) with its own matching + slot and partially rotated, can be placed as a barrier to escaping fluids.

Vanes #174 are inserted through both OPNACLs' slots into the pot's (#180) contents.

Knob #170 is used to rotate the Vanes (#174) as and when desired to stir.

The Smaller OPNACL (#178), turned/out of phase, enough to mask the + slots underneath, will minimize any fluid escape. The idea is to eliminate the need to lift the lid to stir the contents of the pot.

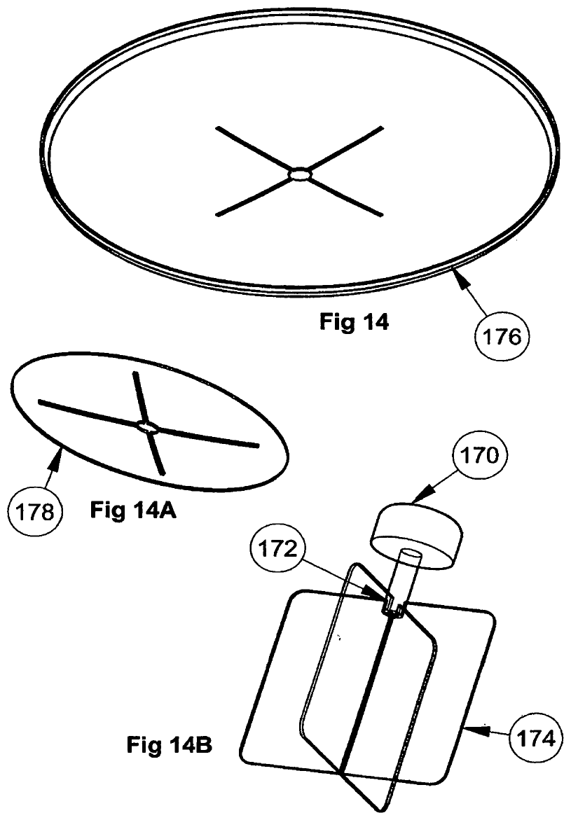

Referring to FIGS. 14, 14A & 14B:

The detailed views of OPNACL (#176) with a wall & a + shaped slot, smaller OPNACL (#178), Content Stirrer (#172) with Vanes (#174) & Knob (#170).

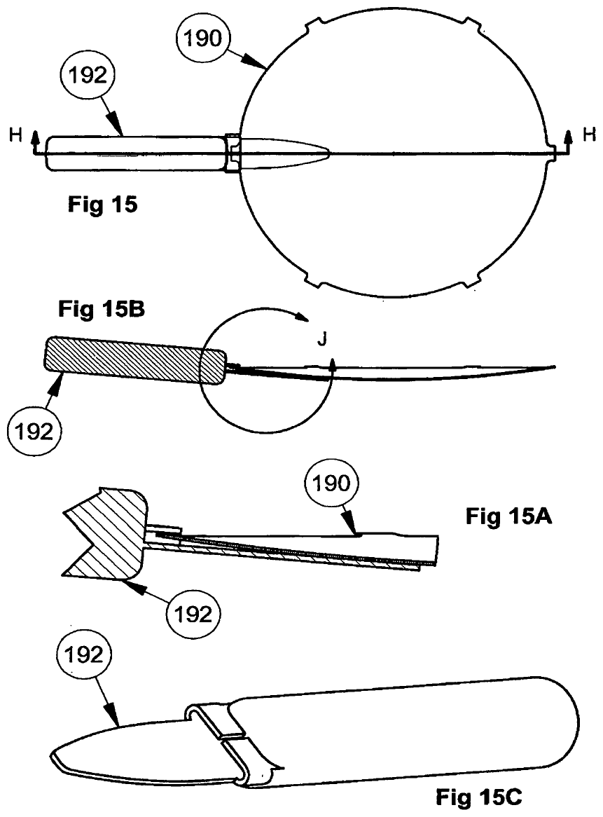

Referring to FIGS. 15, 15A, 15B & 15C:

5^{th} Embodiment: a spherical OPNACL having Radial Tangs (#190) & the OPNACL being handled by a specially made OPNACL Tang-Handler (#192)

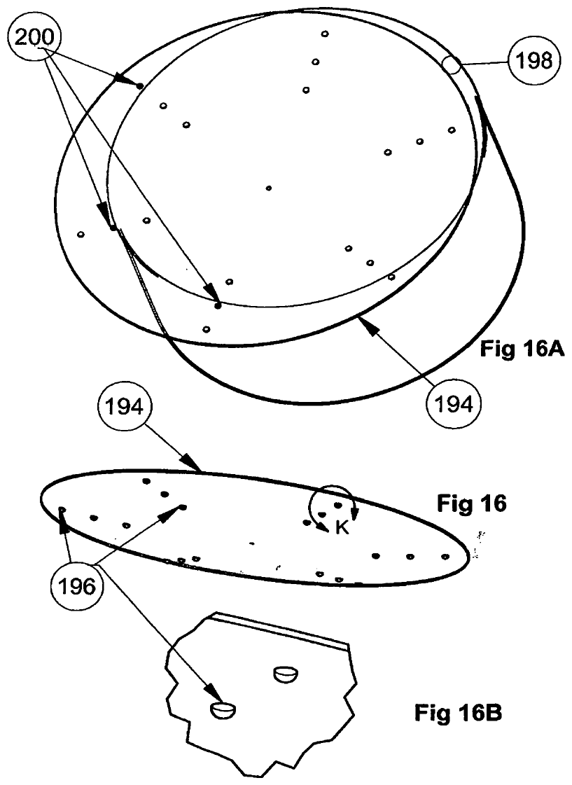

Referring to FIGS. 16, & 16A:

6^{th} Embodiment (#194). The OPNACL has small bumps of low but sufficient height (#196) formed on its underside, so as maintain a deliberate off centered position of the OPNACL, and prevent it from sliding down to center itself. Interference of the bumps with the rim of the pot on inside or outside will achieve this. Desired throttling gap #198 is thus maintained.

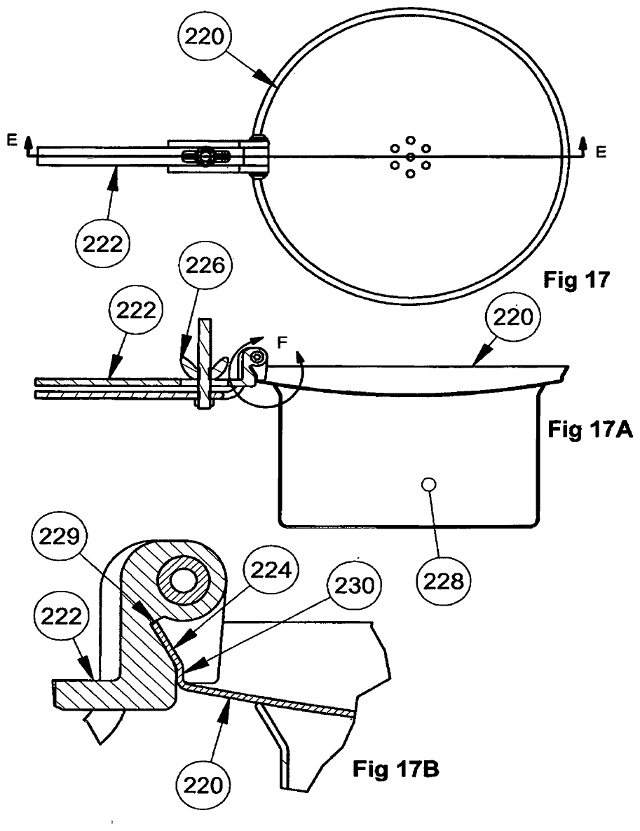

Referring to FIGS. 17, 17A, & 17B:

5^{th} Embodiment: OPNACFL (#220) has a vertical wall with a Flared Flange (#224). A special VGPCFL utensil (#222) can be used, as a gripping handle.

The tightened wingnut (#226) secures the gripped status of the jaws.

#228 is a pot shown for reference, intentionally having the same Flared Flange design, and thus the pot may also be handled by the same utensil.

Note: if the vent holes in #220 are eliminated and, say, 1^{st} embodiment style is used, the OPNAL shown in #220 can be used as a design for a frying pan.

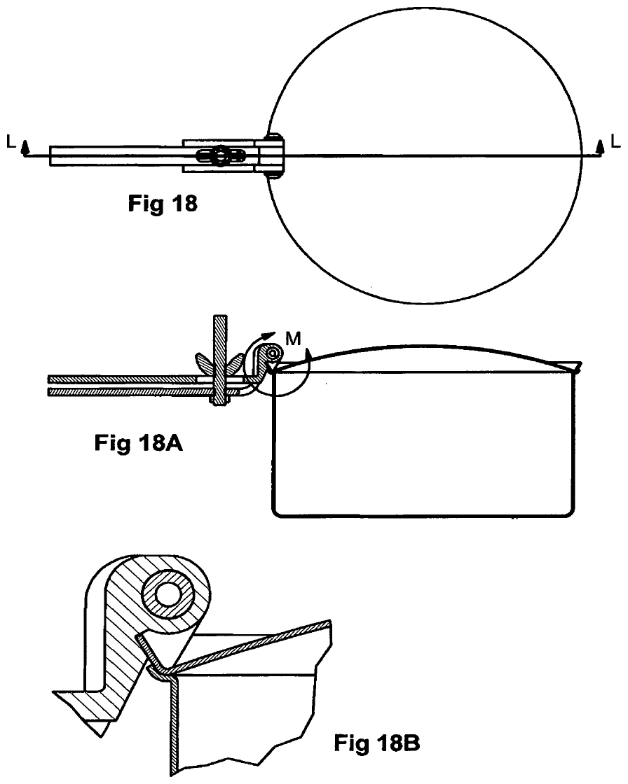

Referring to FIGS. 18, 18A & 18B:

They show the use of a VGPCFL gripping a OPNAXLF by its flange. Though this convex lid needs no attachments, and can be compactly stacked it still has the other disadvantages of a convex lid mentioned above.

### CONCLUSIONS

Accordingly, the reader will see that a concave lid for pots, having no attachments, has numerous advantages over a conventional convex lid.

A convex lid poses the following disadvantages, all of which a concave lid overcomes.

A convex lid:
needs to have attachments for handling,
needs to be individually sized for each pot opening,
needs to be individual, in its rim designed for each pot's rim design,
drains condensates dis-advantageously radially out to the rims of the lid & pot, be the condensates be on the underside or upper side of the lid,
has attachments that make stacking of lids for storage not possible,
makes thorough cleaning difficult due to the presence of nooks & crannies at its rim & Its attachments,
needs precise placement when in use over the pot opening,
necessitates complex rim design & matching pot opening design,
makes ideal vent holes' placement difficult due to attachments' interference,
being top heavy, is less stable on the pot.

I claim:

1. A concave lid with no handles,
said lid comprising,
(a) a concave shaped underside surface and a concave shaped upper side surface, wherein:
said underside surface and said upper side surface are substantially parallel to each other, and substantially equal in area to each other, and
the center of said lid's concavity is lower in elevation than said lid's rim, when said lid is placed on a pot's opening,
wherein said pot's opening is smaller in diameter than the diameter of said lid,
whereby said lid can be utilized as a cover for a pot opening having diameter smaller than the diameter of said lid,
and said lid further comprising:
(b) a plurality of through passages between said upper side surface and said underside surface, and
(c) a means to reduce the encroached volume into said pot by said lid's concavity, when said lid is placed on said pot's opening, and
(d) a means to increase the enclosed volume within said upper side concave surface, and
(e) a means to handle said lid by gripping said lid, substantially along said lid's rim, and
(f) a means to maintain an off centered placement of said lid,
when said lid is placed off centered on said pot,
wherein,
said off centered position is advantageous to vent and throttle the escaping fluids from the inside of said pot.

2. In claim 1, said concave surface is substantially spherical.

3. In claim 1, said concave surface is substantially conical.

4. In claim 1, said through passages are holes between said surfaces.

5. In claim 1, said means to reduce said encroached volume is by deforming a fractional portion of said lid's concave surfaces into substantially convex surfaces.

6. In claim 1, said means to increase said volume within said upper side is the deforming of said lid's rim into a cylindrical wall, whereby said upper side will accommodate larger volume of condensate.

7. In claim 1, said means to grip said lid is substantially a vertical cylindrical wall integral with said lid's rim,
whereby a gripper utensil can grip said wall.

8. In claim 1, said means to grip said lid is a vertical cylindrical wall provided with a plurality of circumferential grooves in said wall,
whereby a gripper utensil can grip said wall and said grooves.

9. In claim 1, said means to grip said lid is a flared flange at the rim of said lid,
whereby a gripper utensil can grip said flange.

10. In claim 1, said means to grip said lid is the provision of a plurality of substantially radial protrusions at said lid's rim, said protrusions being integral with said upper side surface and said underside surface,
whereby said protrusions can be gripped to handle said lid.

11. In claim 1, said means to maintain said lid in said off centered position is the provision on said underside surface, a plurality of substantially small projecting bumps,
whereby said bumps can be utilized as interfering projections against the inside or outside of said pot's rim, whereby said interference prevents sliding of said lid.

12. The method of using a concave shaped lid to cover the opening of a pot, wherein said concave shape encroaches into the pot below said opening, and wherein said lid comprises:
a plurality of through passages between said lid's upper side surface and said lid's underside surface,
whereby with said method of using,
gravity will direct any condensate accumulating on said lid's underside radially inward and down toward the central region of said underside, and further,
gravity will direct any condensate accumulating on said upper side, radially inward and down toward the central region of said upper side,
and thereby said condensates will return back into said pot.
